(19) United States
(12) Patent Application Publication
(10) Pub. No.: US 2011/0279222 A1
(43) Pub. Date: Nov. 17, 2011

(54) TRAVEL ASSISTANT FOR THE VISUALLY IMPAIRED

(76) Inventor: Franklin LeGree, Rochester, NY (US)

(21) Appl. No.: 13/091,695

(22) Filed: Apr. 21, 2011

Related U.S. Application Data
(60) Provisional application No. 61/343,007, filed on Apr. 23, 2010.

(51) Int. Cl. G09B 21/00

(52) U.S. Cl. 340/4.1

(57) ABSTRACT

The present invention relates to a system for guiding the blind, visually impaired, and low vision riders to a specific transportation device (mobile landmark) on a transit system. The network for guiding individuals through a transportation system involves at least one transmitter displaced on a transportation vehicle which identifies the specific identity of said transportation device by transmitting an identity signal that is recognized by interface of handheld apparatus.

### CROSS-REFERENCE TO RELATED APPLICATIONS

I claim the benefit of the filing date of provisional application Ser. No. 61/343,007, filed Apr. 23, 2010, the content of which is hereby incorporated by reference into this specification.

### BACKGROUND OF THE INVENTION

1. Field of the Invention

The invention relates to guiding devices for use by persons including, but not limited to, the blind, visually impaired, low vision, and sighted persons.

2. Prior Art

Guiding devices have been designed in which a signal is transmitted out from the device and is received by nearby mobile landmark and returned to device, this in the manner of a simplified type of radio frequency to thereby operate a signaling means to audibly indicate to the user that a mobile landmark is nearby. Systems of this type that use some sort of audio feedback to guide the user to their desired mobile landmark may, however, encounter difficulties because audio is highly sensitive to the surrounding environment, and therefore may not be reliable in noisy conditions.

Also, a further shortcoming of such prior art that require the permanent installation of bases and or transmitters that emit signals to handheld receivers that decode signals into an audio message, is the potential prohibitive cost users would incur when purchasing a receiver. Another short-coming of such prior art is that while the systems' technology is able to direct the user to the appropriate bus bays and platforms and accompanying information on the bus numbers, directions, and destination, users, however, were missing the vital piece of information they needed to enable a seamless travel experience—information on approaching buses. In general, systems of this sort have enabled users to navigate the transit system more efficiently and with greater confidence and independence, though users cite that the coverage and placement of transmitters was better at some stations than at others. The lack of transmitters on buses limits the value of the system to users. The receiver is of little value to the user if the transmitter is not deployed at all transit stations and bus stops.

The prior art, as reflected in the above, is unquestionably of great value to the blind or visually impaired person if he or she is fortunate enough to live or work in an area which is able to afford systems of such and cost and sophistication.

U.S. Pat. No. 5,241,307 to Bidault et al. discloses a sound signaling and optical signaling system utilized at a crosswalk. The depression of a button for a predetermined amount of time alerts the user with a sound message, as well as with an optical message using green and red figurines. The generation of the second signal is controlled by a microprocessor.

U.S. Pat. No. 5,144,294 to Alonzi et al. discloses an apparatus for aiding the blind comprising a portable, radio frequency transceiver and a stationary, radio frequency base transceiver unit. The transceiver is carried by the individual and transmits a message request signal in response to manual activation of a transmit button

U.S. Pat. No. 5,032,836 to Ono et al. teaches a portable guide device for the visually handicapped including a radio frequency oscillator. The position indicator unit is disposed at a desired place and includes a radio frequency signal receiver and a loud speaker.

U.S. Pat. No. 4,935,907 to Friedman discloses a homing system for directing the user to a specified location comprising a plurality of remote modules and a mobile module.

U.S. Pat. No. 4,660,022 to Osaka discloses a system for guiding the blind including at least one receiver/sound generator unit having a built-in sound generator giving information on the destination of the user, a receiver for actuating the sound generator in accordance with a control signal coming from outside, and a transmitter/control unit carried by the user for producing the control signal.

U.S. Pat. No. 4,253,083 to Imamura discloses a traffic signal system for the blind having a sound system generator electrically connected to a blue light of the traffic signal device which generates a signal representative of sound synchronous with the lighting of the blue light.

U.S. Pat. No. 4,025,922 to Trawick, III discloses a traffic control system including an interrogating FM radio transmitter-receiving unit, which can be incorporated into a cane, and a responding FM radio receiver transmitter unit operatively associated with the traffic signal light control circuit at a street intersection.

U.S. Pat. No. 3,993,407 to Moricca et al. teaches a poly-sensory mobility aid comprising first and second signal generating means which produce audio frequency signals coupled to respective electrically operable stimulating devices for providing both tactile and auditory stimulation. Each of the signal generating means includes two camera means that generate signals representative of the brightest of optical images projected thereon. The prior art, as reflected above, teaches numerous variations on the idea of sound transmission and sensing to aid the visually impaired, the prior art fails to teach the system of the present invention which involves an interface system for receiving and transmitting retrieved GPS data and a RFID reader that reads RFID tags installed on every transportation device and stop which enables the identification of a specific transportation device and stop on a transportation system.

### BRIEF SUMMARY OF THE INVENTION

The present invention relates to a system for guiding the blind, visually impaired, and low vision riders to a specific transportation device (mobile landmark) on a transit system. The network for guiding individuals through a transportation system involves at least one transmitter displaced on a transportation vehicle which identifies the specific identity of said transportation device by transmitting an identity signal. The network also includes a wireless handheld interface device with a transceiver that recognizes the identity signal from said vehicle transmitter and which also enables direct communication to and from a computer interface system that is linked to a GPS data base. The object of the computer interface system is to facilitate receiving and transmitting retrieved GPS data to said wireless handheld interface device. Further, the wireless handheld interface device includes a numeric, Loc-Dots key pad.

Going forward, the wireless handheld interface device will simply be referred to as handheld apparatus.

The network further includes at least one address identifier disposed at a stop on said transportation network that is recognizable by said handheld apparatus. The present invention also includes at least displaced one vehicle identifier displaced on a transportation vehicle which identifies the specific identity of said transportation device. The network further includes a held apparatus that recognizes the vehicle identifier. The network further provides at least one address identifier disposed at a stop on said transportation network that is recognizable by said handheld apparatus.

### BRIEF DESCRIPTION OF THE SEVERAL VIEWS OF THE DRAWINGS

FIG. 1 is a three dimensional perspective view of a wireless handheld interface device of the left vertical axis and of the top and bottom horizontal axes;

FIG. 2 is a three dimensional perspective view of a wireless handheld interface device of the right vertical axis and of the top and bottom horizontal axes;

FIG. 3 is an inverted front perspective view of a wireless handheld interface device.

FIG. 4 is a backside perspective view of a wireless handheld interface device.

FIG. 5 is a front perspective view of a wireless handheld interface device.

FIG. 6 is a detailed flowchart of real-time use of handheld apparatus

FIG. 7 is a work breakdown structure between the interface system, handheld apparatus, and augmented passive RFID tags with GPS

### DETAILED DESCRIPTION OF THE INVENTION

The present invention relates to a network for guiding the blind, visually impaired, and low vision persons through a transportation network by means of a handheld apparatus.

The handheld apparatus may include one or more housing materials such as plastic, metal, ceramic, glass, and so forth, suitable for enclosing and protecting the internal component of the handheld apparatus. The handheld apparatus may comprise various internal components such as, for example, a circuit board; at least three voltage regulators; three accelerometers; three compasses; at least one RFID reader; RFID reader antenna; circuit surfboard; GPS receivers; resistors; capacitors; vibration motor and motor hold down.

The present invention also includes at least one transmitter displaced on a transportation vehicle which identifies the specific identity of said transportation device by transmitting an identity signal. The network also includes a handheld apparatus that includes a numeric, Loc-Dots key pad and said handheld apparatus further includes a receiver that recognizes the identity signal from said vehicle transmitter. The network further includes at least one address identifier disposed at a stop on said transportation network that is recognizable by said handheld apparatus.

The present invention also includes at least displaced one vehicle identifier displaced on a transportation vehicle which identifies the specific identity of said transportation device. The network further includes a handheld apparatus that recognizes the vehicle identifier. The network further provides at least one address identifier disposed at a stop on said transportation network that is recognizable by said handheld apparatus.

In operation, the device of the present invention could be utilize in a manner, for instance, a user of the present invention trying to locate and access a transportation device (mobile landmark) on a transportation system would depress a selected key on the numeric, Loc-Dots key pad in order to transmit a signal that identifies/locates a stop that is situated on a transportation system. Installed on every stop throughout a transportation system are RFID tags which enable the identification of said stop on a transportation system.

Further, installed on every transportation device (mobile landmark) on a transportation system are RFID tags which enable the identification of said transportation device on a transportation system. The handheld apparatus is outfitted with a RFID reader and a RFID reader antenna which facilitates the identification and location of any transportation device and any stop on said transportation system. The handheld device is further outfitted with a user interface system that provides the means for receiving a location indicator.

The means for alerting user of said handheld apparatus that a transportation device and stop has been located and identified is accomplished by triggering the vibration of said handheld apparatus. The object of the handheld apparatus is to enable the user to select desired bus on a transportation system. The user of said handheld apparatus arrives at stop on transportation system. User selects desired transportation device, that is, a bus by depressing a selected key or combination of keys on the numeric, Loc-Dots key pad which corresponds with the route number of the selected transportation device.

User of said handheld apparatus waits for desired bus. User obtains bus location when the bus stops via GPS. GPS looks up user location. Once user location has been determined, a vector is created. Vector is then sent to handheld apparatus. Transportation device, that is, bus is accessible to user. User boards desired transportation device. In the event the transportation device moves from its initial stop location after the vector has been transmitted to handheld device, the interface system will obtain transportation devices' new location, approximate user's location, create new vector, send vector to handheld apparatus. In the event the user deviates from path, interface system approximates user location, creates new vector, send vector to handheld device.

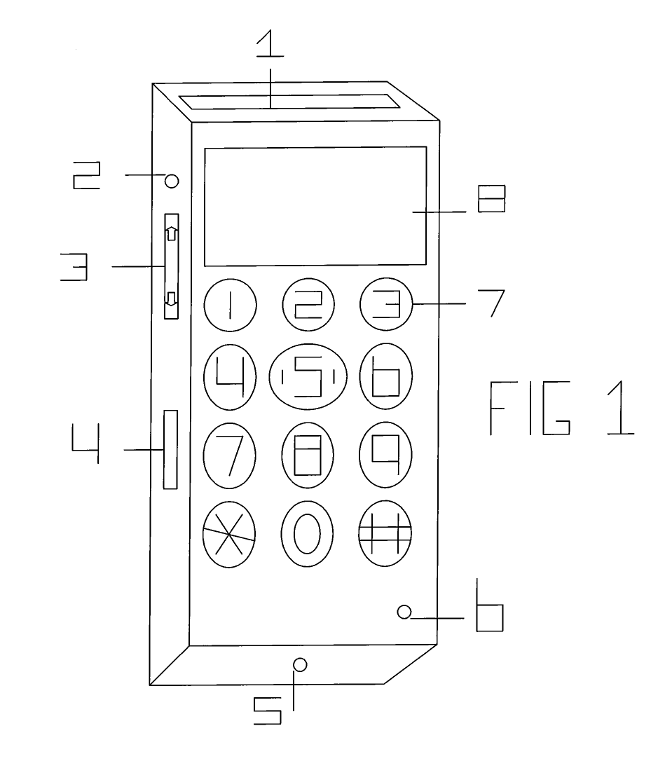

Referring now to the drawings, there is illustrated, in FIG. 1 a translucent window indicated as element 1. There is also illustrated in FIG. 1 a headphone jack which is indicated by element 2 for the utilization of a pair of headphones. Headphones can be utilized for private audibility and listening of music that can be played by the handheld apparatus by inserting a micro-memory card loaded with pre-recorded material into the micro-memory card slot indicated by element 4. The handheld apparatus also illustrates a volume control button which is indicated by element 3. Element 5 illustrates a DC jack that will be utilized for recharging handheld apparatus. Element 6 illustrates an on/off power button. Element 7 illustrates a Numeric, Loc-Dots keypad that will be utilized for transmitting signal to transportation device/mobile landmark. Element 8 illustrates a product name plate.

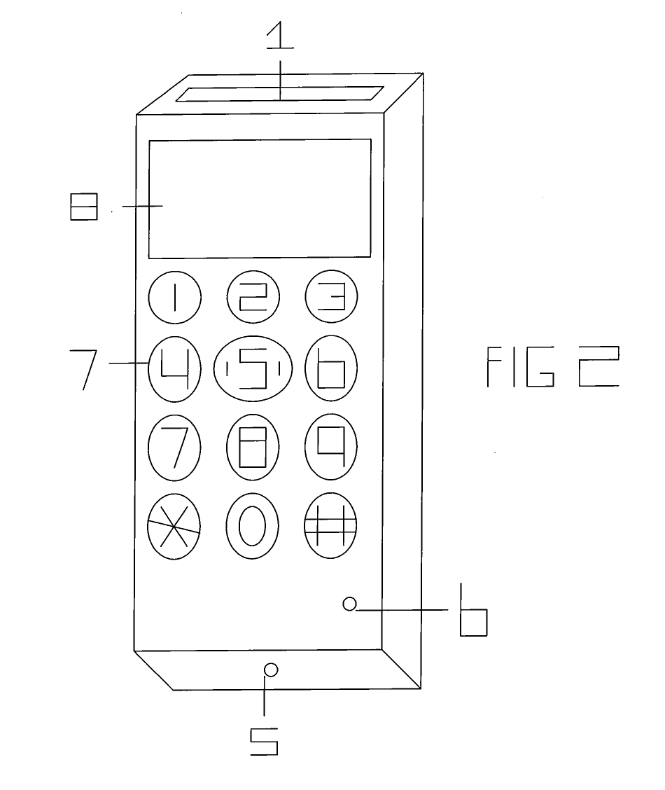

FIG. 2 is depicting a translucent window indicated by element 1. Element 7 illustrates a numeric, Loc-Dots keypad that will be utilized for transmitting signal to transportation device/mobile landmark. Element 6 illustrates an on/off power button. Element 5 illustrates a DC jack that will be utilized for recharging handheld apparatus. Element 8 illustrates a product name plate.

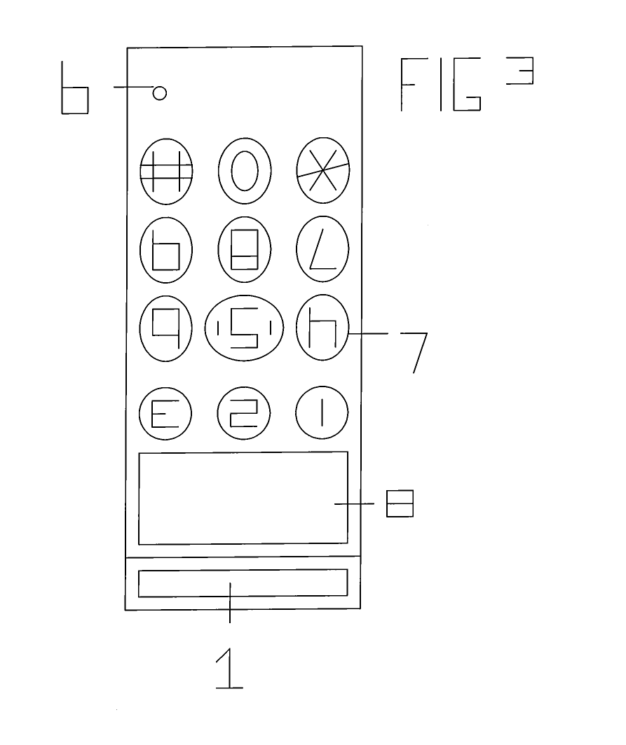

FIG. 3 is depicting a translucent window which is indicated by element 1. Element 7 illustrates a numeric, Loc-Dots keypad that will be utilized for transmitting signal to transportation device/mobile landmark. Element 6 illustrates an on/off power button. Element 8 illustrates a product name plate.

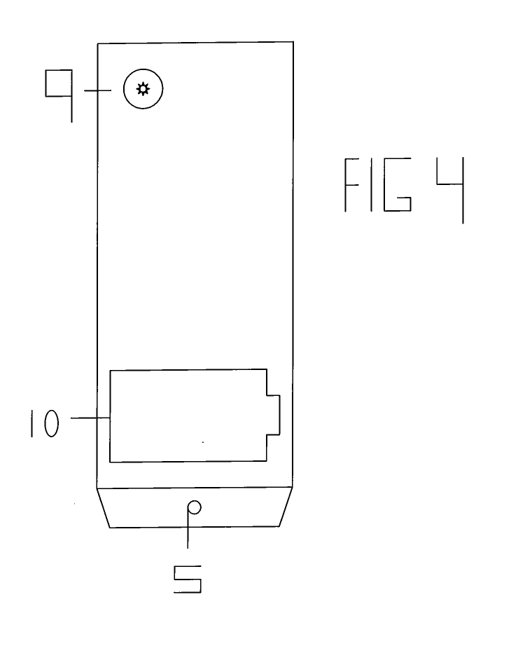

FIG. 4 illustrates a speaker that is indicated by element 9 which will be utilized to provide audibility. Element 10 illustrates cover to battery compartment. Element 5 illustrates DC jack that will be utilized for recharging handheld apparatus.

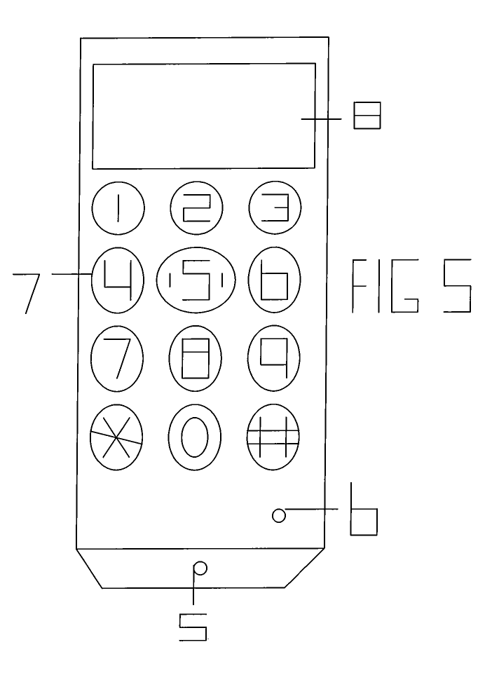

FIG. 5 illustrates a DC jack that is indicated by element 5 which will be utilized for recharging handheld apparatus. Element 6 illustrates an on/off power button. Element 7 illustrates a numeric, Loc-Dots keypad that will be utilized for transmitting signal to transportation device/mobile landmark. Element 8 illustrates product name plate.

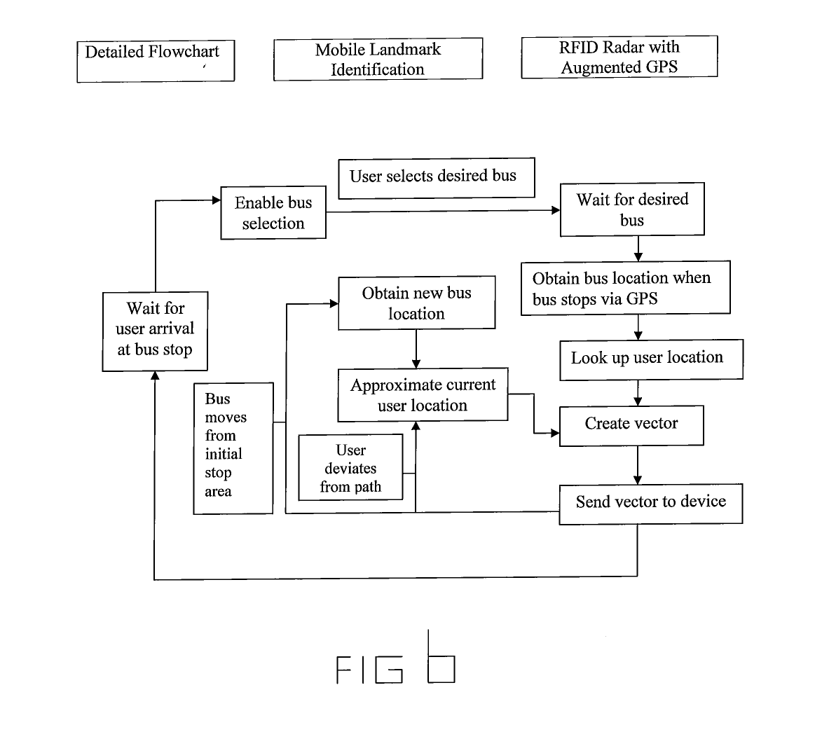

FIG. 6 is a detailed flowchart of real-time use of handheld apparatus in conjunction with RFID radar with augmented GPS.

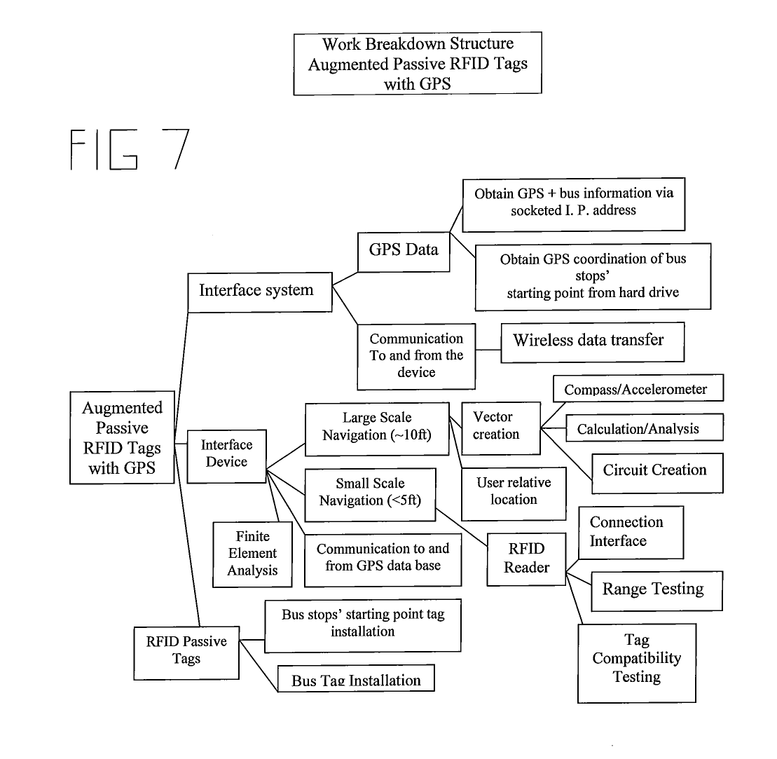

FIG. 7 is a detailed work breakdown structure between the interface system, handheld apparatus, and augmented passive RFID tags with GPS.

1. A transportation network for guiding individuals through a transportation network comprising:
At least one transmitter disposed on a transportation vehicle which identifies the specific identity of said transportation vehicle by transmitting an identity signal;
A handheld apparatus with a receiver that recognizes the identity signal from said transmitter;
At least one address identifier disposed at a stop on said transportation network that is recognizable by said handheld apparatus.

2. (canceled)

3. A handheld apparatus for guiding an individual through a mass transit system comprising:
a user numeric, Loc-Dots interface that allows the user to input desired destinations;
means for receiving a location indicator; and
means for receiving transit system information from an information source;
wherein said interface communicates destination and transit asset status to the user;
auditory means for providing instructions to the user;
means for inputting desired destinations into the apparatus by the user.

4. The apparatus of claim 3 wherein said numeric, Loc-Dots interface is a keypad.

5. The apparatus of claim 3 wherein said means for inputting is a wireless keypad

6. The apparatus of claim 3 wherein said means for receiving a location indicator is a GPS
mapping means,

7. The apparatus of claim 3 wherein said means for receiving transit system information is a pre-published schedule.

8. The apparatus of claim 3 wherein said means for receiving transit system information comprises a transmitter located on a bus; a GPS receiver on said bus wherein said transmitter transmits the GPS coordinates of said bus; a central receiver that monitors the GPS coordinates of said bus.

9. The apparatus of claim 3 wherein said handheld apparatus also comprises means for receiving a bus location.

10. A handheld device comprising:
A case having an input interface; a memory card reader; a information processor; a global positioning system; a audio system with a speaker; and a radio frequency receiver; and a radio frequency transmitter;
Wherein said input interface inputs a desired location to said information processor and said information processor interfaces with said global positioning system to determine the global position of said handheld device and said information processor determines a route from said global position to a first station on a transit system and provides audio directions to said transit system station and wherein said information processor connects to a set of transit information data that provides routes and times of transit system vehicles so that the information processor can provide directions as to what vehicle will go from said first station to a final station on route to said desired location.
